(19) United States
(12) Patent Application Publication
(10) Pub. No.: US 2003/0107520 A1
(43) Pub. Date: Jun. 12, 2003

(54) Adjustable mount for dual-mode car radio antenna

(75) Inventors: Neil D. Terk, Laurel Hollow, NY (US); Jean-Jacques L'Henaff, New York, NY (US); Stephen Patti, Bethpage, NY (US); Michael Hartigan, Boca Raton, FL (US); Harold Terk, Stamford, CT (US); Stuart Reinhardt, Oyster Bay, NY (US)

Correspondence Address: Gerald T. Bodner, Esq., HOFFMANN & BARON, LLP, 6900 Jericho Turnpike, Syosset, NY, 11791, US

(73) Assignee: Terk Technologies, Inc.

(21) Appl. No.: 10/021,110

(22) Filed: Dec. 7, 2001

(51) Int. Cl. H01Q 1/32

(52) U.S. Cl. 343/713; 343/711; 343/906

(57) ABSTRACT

An automobile radio antenna includes an outside coupler unit adapted to be mounted to an exterior surface of an automobile window, an inside coupler unit adapted to be mounted to an interior surface of an automobile window and aligned with the outside coupler unit and an antenna mast pivotably attached to the outside coupler unit. The antenna mast is angularly adjustable with respect to the outside coupler unit. A kit for installing an automobile radio antenna on a window of an automobile includes an outside coupler unit adapted to be mounted to an exterior surface of an automobile window and having an antenna mast connected thereto, an inside coupler unit adapted to be mounted to an interior surface of an automobile window and aligned with the outside coupler unit, an outside coupler unit template having a cut-out portion for positioning the outside coupler unit on the exterior surface of the automobile window and an inside coupler unit template having a cutout portion for positioning the inside coupler on the interior surface of the automobile window. A method for installing an automobile radio antenna on an automobile window includes the steps of positioning an outside coupler unit template having a cut-out portion on an exterior surface of the automobile window, aligning an inside coupler unit template having a cut-out portion with the outside coupler unit template on an interior surface of the automobile window, mounting an outside coupler unit having an antenna mast assembly to an exterior surface of the automobile window by positioning the outside coupler unit within the cut-out portion of the outside coupler unit template, mounting an inside coupler unit for electrically communicating with the outside coupler unit to an interior surface of the automobile window by positioning the inside coupler unit within the cut-out portion of the inside coupler unit template and removing the outside and inside coupler unit templates from the automobile window once the outside and inside coupler units have been mounted to the window.

### FIELD OF THE INVENTION

The present invention relates to automobile radio antennas, and more particularly to an aerodynamic, adjustable, dual-mode radio antenna mounted to a window of an automobile.

### BACKGROUND OF THE INVENTION

Automotive vehicles are commonly equipped with an audio system and a corresponding antenna system to receive amplitude modulation (AM) and frequency modulation (FM) broadcast radio signals. Recently it has been desired to provide automobile audio systems for receiving radio waves transmitted from a satellite by using an antenna system mounted on an automotive vehicle.

Such antenna systems, whether terrestrial or satellite, are typically mounted externally to the motor vehicle and include electronics, such as a pre-amplifier, for receiving the transmitted radio waves and for generating signals to be sent to a receiver that is typically located within the motor vehicle. In turn, electrical power for the satellite electronics must be provided to the antenna system from the receiver. Thus, installation of such antenna systems requires the delivery of RF signals from the antenna electronics outside the motor vehicle to a receiver inside the vehicle and the delivery of electrical power from the receiver to the antenna electronics.

One conventional vehicle antenna system includes a mast antenna vertically extending from the body of the vehicle. A related conventional vehicle radio antenna includes telescopic extensible antenna elements comprising a plurality of conductive pipes of different diameters movably connected to one another. Another conventional vehicle radio antenna includes a back-light antenna system in which antenna elements are embedded in a rear window of the vehicle.

Generally, it is desired that an antenna for use in an automotive vehicle be mounted on the vehicle so that it does not impede on the automobile's aerodynamic characteristics or the appearance of the vehicle. Most conventional antenna systems, particularly those for receiving satellite radio waves, are rather large and cumbersome. These conventional antenna systems generally interfere with the automobile's aerodynamic characteristics and detract from the external appearance of the vehicle.

Another drawback with conventional antenna systems, particularly with electrically extensible car antennas, is the high risk that the antenna element and its surrounding areas will become damaged if an object impacts the antenna element in its extended state while the car is traveling. Another common risk of damage to the antenna occurs when the vehicle is being washed, either in commercial car washes or by the vehicle owner.

Yet another disadvantage with conventional antenna systems is that typical installation requires drilling a hole through the vehicle structure or window to provide passage for a coaxial cable to carry the signals from the antenna to the receiver and the electrical power from the receiver to the antenna electronics. In many cases drilling a hole through the vehicle structure is undesirable. In particular, drilling a hole in a window of a motor vehicle, especially to allow attachment of an after market car radio antenna, may cause damage to the window or affect the integrity of the window. The hole may leak if not properly sealed, and remains as an unsightly remnant, which requires plugging if the antenna system is ever removed.

While it has been known to provide through-glass antennas utilizing electrodes clamped on both sides of a window glass for passing signals therethrough without the need for drilling a hole in the window, such antennas are typically difficult to install requiring a great deal of expertise in the installer. For example, any metal objects in the vicinity of the antenna will have a great influence on the passing of the signal and, therefore, extreme care must be exercised in properly positioning the antenna.

Therefore, there is a need in the art for a simple system for installing an automobile audio system antenna on a motor vehicle without drilling a hole through the vehicle's structure where the system is being installed. It would further be desirable for the antenna system to maintain the automobile's aerodynamic characteristics and appearance while at the same time being less prone to damage by impact.

### OBJECTS AND SUMMARY OF THE INVENTION

It is an object of the present invention to provide an automobile audio system antenna that can be easily and precisely mounted to an external window of an automobile for passing signals through the window using through-glass technology to eliminate drilling during installation.

It is another object of the present invention to provide a dual-mode car radio antenna for simultaneously receiving radio signals from satellites and from terrestrial transmitters to ensure continuous reception.

It is yet another object of the present invention to provide an aerodynamic glass-mounted car radio antenna having an angularly adjustable hinged mast that can be set to any angle for optimum reception.

It is a further object of the present invention to provide an aerodynamic glass-mounted car radio antenna that can absorb impact and can be folded down when desired to avoid damage to the antenna.

It is still another object of the present invention to provide a car radio antenna kit including all of the necessary mounting hardware that is easy to install on any vehicle.

The present invention is an automobile radio antenna, which generally includes an outside coupler unit adapted to be mounted to an exterior surface of an automobile window, an inside coupler unit adapted to be mounted to an interior surface of an automobile window and aligned with the outside coupler unit and an antenna mast pivotably attached to the outside coupler unit. The antenna mast is angularly adjustable with respect to the outside coupler unit.

In a preferred embodiment, the outside coupler unit includes a housing having a main body and two upwardly extending arms and the antenna mast is pivotably attached to the upwardly extending arms. The upwardly extending arms define an opening in the outside coupler unit to allow the passage of wind through the outside coupler unit. The upwardly extending arms further project the antenna mast above the automobile roof line to ensure a proper line of sight for the antenna to the satellite.

The outside coupler unit includes electronic circuitry that is adapted to receive radio signals from an antenna housed in the mast and electrical power from the inside coupler unit, which also includes electronic circuitry. The outside coupler unit, with its associated electronic circuitry, is adapted to send the radio signals from the antenna mast to the inside coupler unit. The inside coupler unit is adapted to receive the radio signals from the outside coupler unit and is adapted to send electrical power to the outside coupler unit. Additionally, the outside and inside coupler units each include an adhesive gasket for adhesively mounting the outside and inside coupler units to the automobile window. Preferably, the outside coupler unit also includes a positioning light emitting diode (LED), which illuminates when the outside and inside coupler units are properly aligned.

In a preferred embodiment, the antenna mast includes a satellite antenna assembly for receiving satellite radio signals, a terrestrial antenna assembly for receiving terrestrial radio signals and a radome for containing the satellite antenna assembly and the terrestrial antenna assembly therein. The satellite antenna assembly and the terrestrial antenna assembly are linearly aligned within the radome of the antenna mast.

The antenna mast further preferably includes a friction pivot assembly, which is pivotably attached to the outside coupler unit for providing a biasing frictional force against angular adjustment of the antenna mast. The friction pivot includes a cylindrical hub having an axial projection, a bushing fitted on the hub projection for rotational frictional engagement therewith and a wave washer fitted on the hub projection for providing a biasing force against the bushing to maintain frictional engagement between the bushing and the hub projection. Preferably, the antenna mast further includes a suction cup for securing the antenna mast to the automobile window in a folded down orientation to protect the antenna mast in low clearance and car wash situations. Alternatively, the outside coupler unit includes a snap-in cavity integrally formed on an upper surface thereof for receiving and securing thereto the antenna mast in a folded down orientation.

The present invention also includes a kit for installing an automobile radio antenna on a window of an automobile. The kit generally includes an outside coupler unit adapted to be mounted to an exterior surface of an automobile window and having an antenna mast connected thereto, an inside coupler unit adapted to be mounted to an interior surface of an automobile window and aligned with the outside coupler unit, an outside coupler unit template having a cut-out portion for positioning the outside coupler unit on the exterior surface of the automobile window and an inside coupler unit template having a cut-out portion for positioning the inside coupler on the interior surface of the automobile window. The kit further preferably includes a protective mast holder having a tubular sleeve adapted to be fitted on the antenna mast and a suction cup for securing the antenna mast to the automobile window in a folded down orientation.

In a preferred embodiment of the kit, the outside and inside coupler unit templates include registration notches for positioning and aligning the templates on the automobile window and at least one self-adhesive portion for temporarily securing the template to the automobile window.

The invention also includes a method for installing an automobile radio antenna on an automobile window. The method generally includes the steps of positioning an outside coupler unit template having a cut-out portion on an exterior surface of the automobile window, aligning an inside coupler unit template having a cut-out portion with the outside coupler unit template on an interior surface of the automobile window, mounting an outside coupler unit having an antenna mast assembly to an exterior surface of the automobile window by positioning the outside coupler unit within the cut-out portion of the outside coupler unit template, mounting an inside coupler unit for electrically communicating with the outside coupler unit to an interior surface of the automobile window by positioning the inside coupler unit within the cut-out portion of the inside coupler unit template and removing the outside and inside coupler unit templates from the automobile window once the outside and inside coupler units have been mounted to the window.

In a preferred embodiment, the method further includes the step of electrically connecting the inside coupler unit to the automobile's receiver and illuminating at least one positioning LED (or other illuminating device) provided on at least one of the outside and inside coupler units when the outside and inside coupler units are properly aligned. The steps of positioning and aligning the outside and inside coupler unit templates preferably include the step of positioning registration notches formed on the templates clear of any defroster or antenna lines on the automobile window. Additionally, the method further preferably includes the step of angularly adjusting the antenna mast assembly with respect to the outside coupler unit once the outside coupler unit has been mounted to the automobile window.

A preferred form of the adjustable dual-mode automobile radio antenna, kit and method for installation as well as other embodiments, features and advantages of this invention, will be apparent from the following detailed description, which is to be read in conjunction with the accompanying drawings.

### BRIEF DESCRIPTION OF THE DRAWINGS

FIG. 1 is a perspective view of the adjustable dual-mode automobile radio antenna formed in accordance with the present invention.

FIG. 2 is an exploded view of the outside coupler unit and the antenna mast of the antenna shown in FIG. 1.

FIG. 3 is an exploded view of the inside coupler unit of the antenna shown in FIG. 1.

FIG. 4 is an exploded view of the antenna mast shown in FIGS. 1 and 2.

FIG. 5 is an exploded view of the terrestrial antenna assembly shown in FIG. 4.

FIG. 6 is a cross-sectional view of the friction pivot taken along line 6-6 of FIG. 4.

FIG. 7 is a perspective view of an antenna installation kit formed in accordance with the present invention.

FIG. 8 is a perspective view of the installation templates of the kit shown in FIG. 7 being installed on an automobile window.

FIG. 9 is a perspective view of the outside coupler unit being positioned by an installation template.

FIG. 10 is a perspective view of the inside coupler unit being positioned by an installation template.

FIG. 11 is a perspective view showing the protective mast holder being slipped on the antenna mast of the antenna assembly.

FIG. 12 is a perspective view showing the antenna mast being folded down and secured to the vehicle's window to protect the antenna mast.

FIG. 13 is a perspective view of an alternative embodiment of the outside coupler unit for folding down the antenna mast.

FIG. 14 is an electrical schematic diagram of the electronic circuitry of the inside coupler unit.

FIG. 15 is an electrical schematic diagram of the electronic circuitry of the outside coupler unit.

### DETAILED DESCRIPTION OF THE PREFERRED EMBODIMENTS

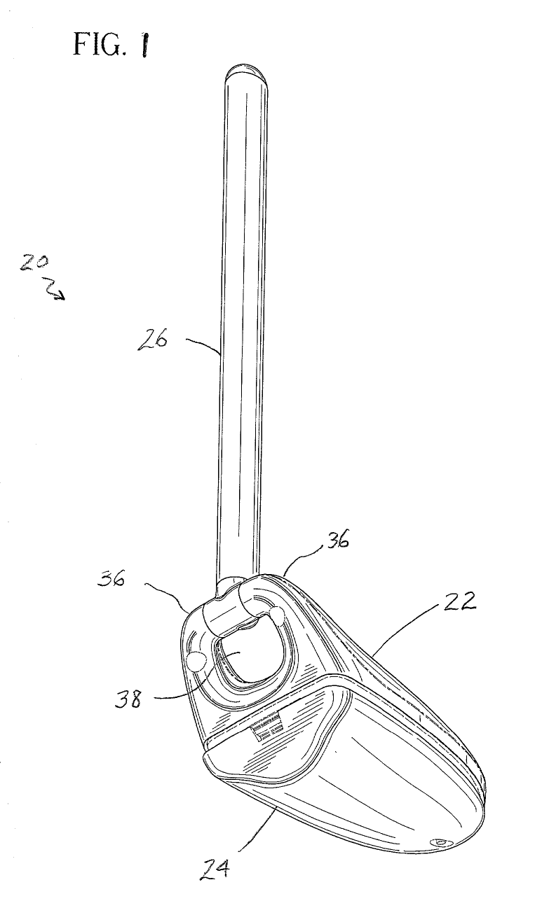

Referring to FIG. 1, an antenna assembly 20 formed in accordance with the present invention is shown. The antenna assembly 20 generally includes an outside coupler unit 22, an inside coupler unit 24 and an antenna mast 26. As will be discussed in further detail below, the antenna mast 26 is pivotally attached to the outside coupler unit 22. The outside coupler unit 22 with the attached antenna mast 26 is mounted to an exterior window surface of an automobile, and the inside coupler unit 24 is mounted to an interior window surface of the automobile and aligned with the outside coupler unit.

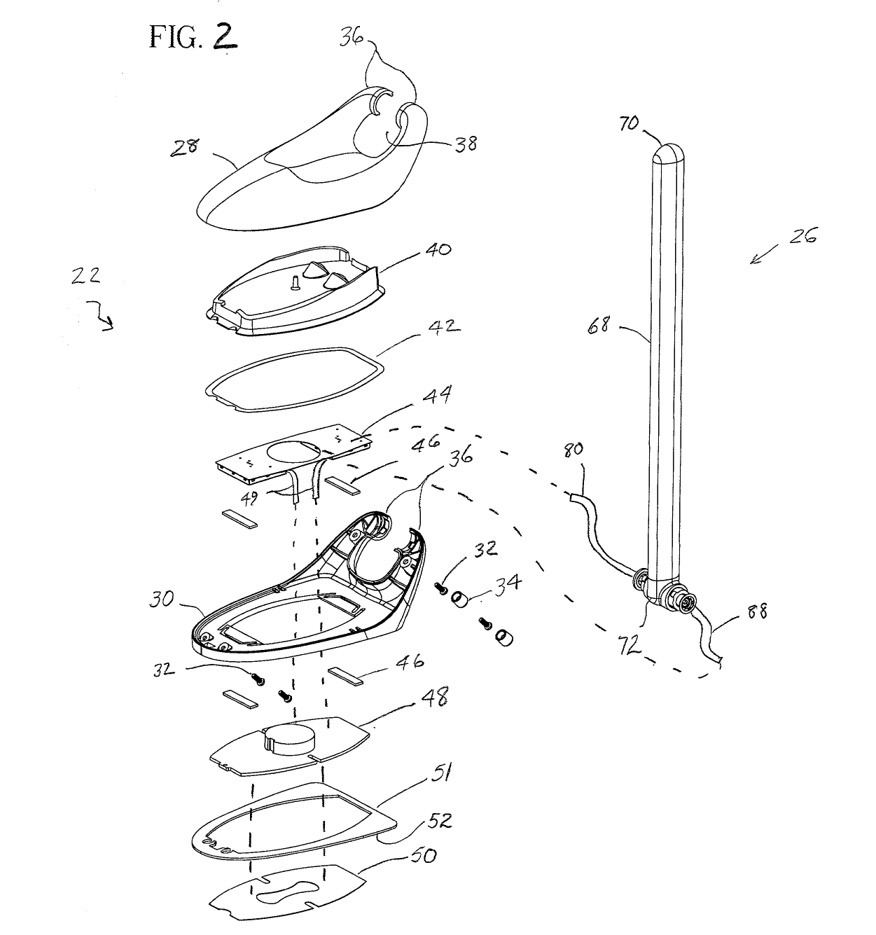

Referring to FIG. 2, the outside coupler unit 22 includes a top housing 28 and a mating bottom housing 30, which together define an interior cavity for containing the components of the outside coupler unit. The top and bottom housings 28 and 30 are preferably made from a durable light-weight plastic material. The mating top and bottom housing halves 28 and 30 are aerodynamically designed and are assembled together in a conventional manner, such as by screws 32, as shown in FIG. 2, or by an adhesive. If assembled with screws 32, rubber or plastic screw plugs 34 are preferably provided to seal the screw holes for aerodynamic purposes.

The mating top and bottom housing halves 28 and 30 each include two arms 36, which, when assembled together, securely support the antenna mast 26 on opposite sides. The arms 36 extend upwardly from the housing halves 28 and 30 to support the antenna mast in a vertical orientation with respect to the bottom of the outside coupler unit 22 when the unit is mounted on the car window. The two arms 36 also define an opening 38 in the assembled outside coupler unit 22 to allow the passage of wind through the upstanding portion (defined by arms 36) of the outside coupler unit for aerodynamic purposes.

The outside coupler unit 22 further includes a Santoprene® rubber boot 40 contained between the top and bottom housings 28 and 30 to provide a substantially air-tight and water-tight seal between the top and bottom housings. A double-sided adhesive gasket 42 is provided to secure the rubber boot 40 to the bottom housing 30.

The electronics of the outside coupler unit 22 include a low noise amplifier, circuit coupler assembly (CCA LNA) board 44, secured to the bottom housing half 30 by two double-sided adhesive strips 46, and a circuit coupler assembly (CCA) outside coupler board 48 also secured to the bottom housing by adhesive strips 46. Antenna wires 80 and 88 from the antenna mast 26 are electrically connected to the CCA LNA board 44 and the CCA LNA board is electrically connected to the CCA outside coupler board 48 by wires 49. A protective backing 50 is further adhesively secured to the CCA outside coupler board 48 to protect the coupler electronics from the exterior elements.

As will be discussed in further detail below, the outside coupler unit 22 is secured to an exterior surface of an automobile window by means of a double-sided glass adhesive gasket 51 secured to the bottom of the bottom housing 30. The glass adhesive gasket 51 has a protective peel-away coupler backing 52 to protect the glass adhesive gasket 51 prior to installation.

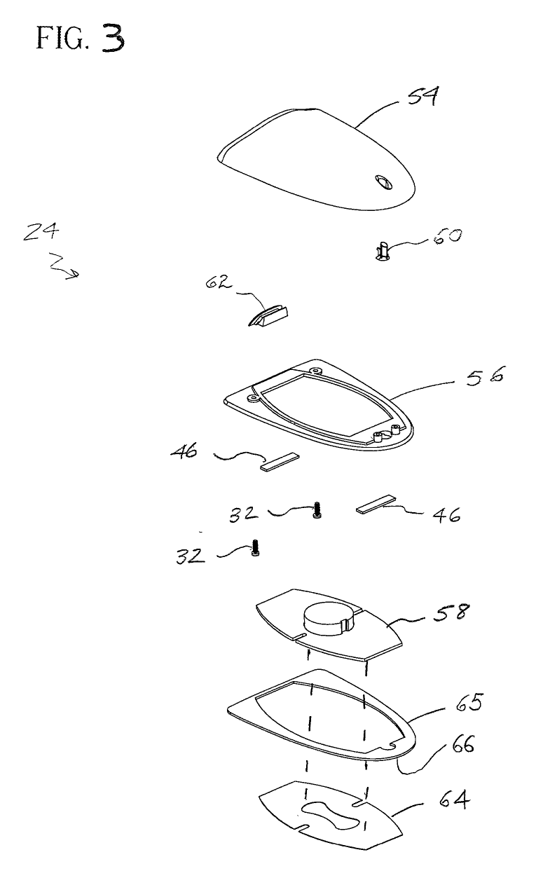

Referring now to FIG. 3, the inside coupler unit 24 includes a top housing 54 and a mating bottom housing 56 which, again, may be fastened together by screws 32. The mating top and bottom housing halves 54 and 56 together define an interior cavity for containing the internal components of the inside coupler unit 24, including an inside coupler printed circuit board (PCB) assembly 58 fastened to the bottom housing by adhesive strips 46 and a positioning light emitting diode (LED) lightpipe 60. As will be discussed in further detail below, the lightpipe 60 permits a positioning LED contained in the outside coupler unit 22 to be visible through the inside coupler unit 24 to assist in aligning the inside coupler unit to the outside coupler unit upon installation. A wiring strain-relief bracket 62 is also provided to secure the external inside coupler unit wiring (not shown in FIG. 3) to the top and bottom housing halves 54 and 56. The external inside coupler wiring preferably comprises a pair of coaxial cables running from the inside coupler unit 24 to the automobile audio equipment. Again, a protective backing 64 is further adhesively secured to the PCB assembly 58 to protect the PCB electronics from the exterior elements.

Similar to the outside coupler unit 22, the inside coupler unit 24 includes a double-sided glass adhesive gasket 65 with a peel-away protective backing 66 secured to the bottom housing 56 for securing the inside coupler unit to an interior surface of an automobile window.

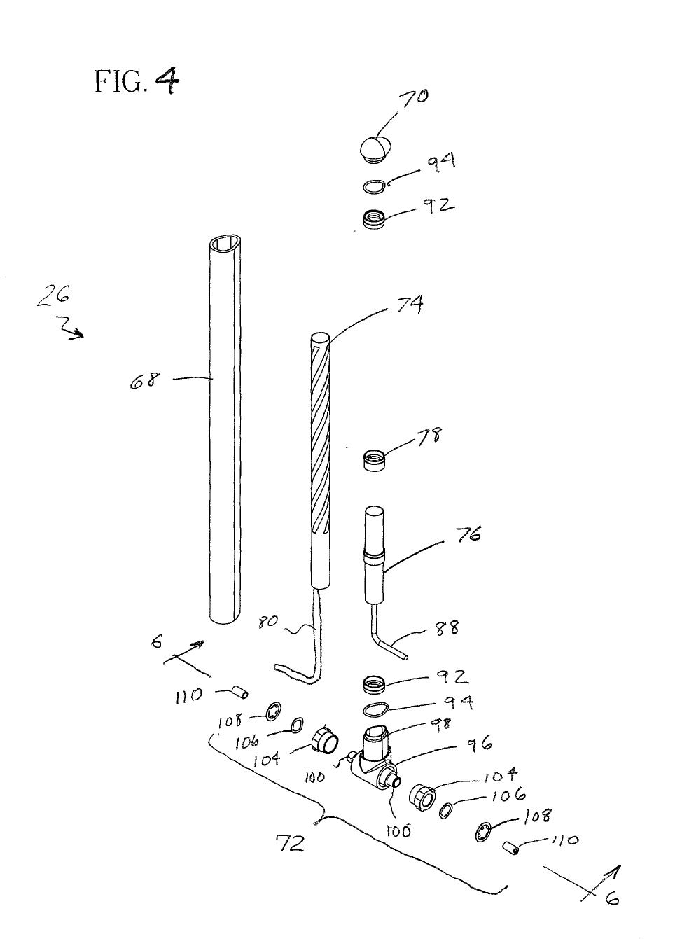

Referring now to FIGS. 2 and 4, the antenna mast 26 generally includes a tubular housing or radome 68 including a radome cap 70, a friction pivot 72, a satellite antenna assembly 74 and a terrestrial antenna assembly 76. The satellite antenna assembly 74 is housed within the radome 68 in line with the terrestrial antenna assembly 76. Preferably, the satellite antenna assembly 74 is positioned within the radome 68 above the terrestrial antenna assembly 76 with a rubber spacer 78 provided therebetween. The lower terrestrial antenna assembly 76 is thus designed to allow passage therethrough of the upper satellite antenna assembly wire 80.

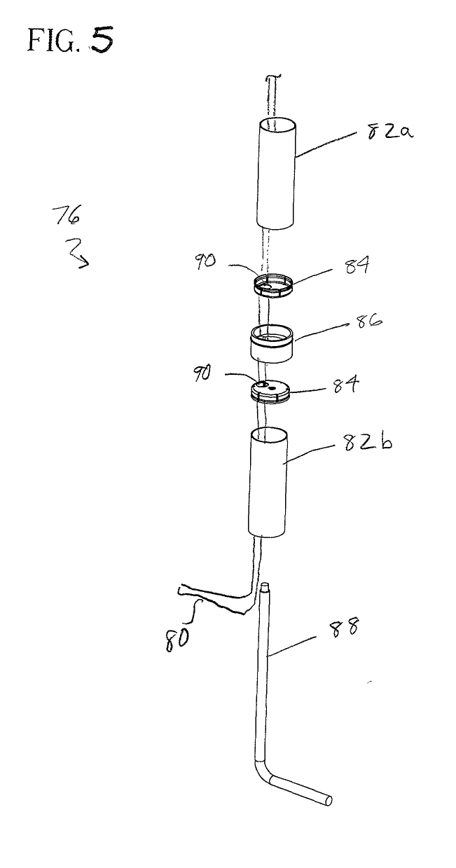

Specifically, as shown in FIG. 5, the lower terrestrial antenna assembly 76 includes two cylindrical metallic sleeves 82a and 82b, each having a terrestrial antenna cap 84 secured to an end thereof. The caps 84 are separated by a rubber spacer 86 and a terrestrial antenna wire 88 is electrically connected to both of the caps and extends through the bottom terrestrial sleeve 82 to exit the antenna radome 68 along with the upper satellite assembly wire 80. The caps 84 include an opening 90 to allow passage of the upper satellite antenna assembly wire 80 through the lower terrestrial antenna assembly. More specifically, the antenna wire 80 of the upper satellite antenna assembly 74 extends through both cylindrical sleeves 82, both caps 84 and the annular rubber spacer 86 of the lower terrestrial antenna assembly 76. Thus, the upper satellite antenna assembly wire 80 will extend out of the bottom of the radome 68 together with the lower terrestrial antenna assembly wire 88.

Returning to FIG. 4, the co-linear upper satellite antenna assembly 74 and lower terrestrial antenna assembly 76 are contained and sealed within the radome 68. Rubber spacers 92 and O-ring seals 94 are provided at opposite ends of the antenna assemblies 74 and 76 to secure the antenna assemblies within the radome 68. The mast cap 70 may then be secured to the radome 68 by means of an adhesive to provide a substantially air-tight and water-tight sealed antenna mast 26.

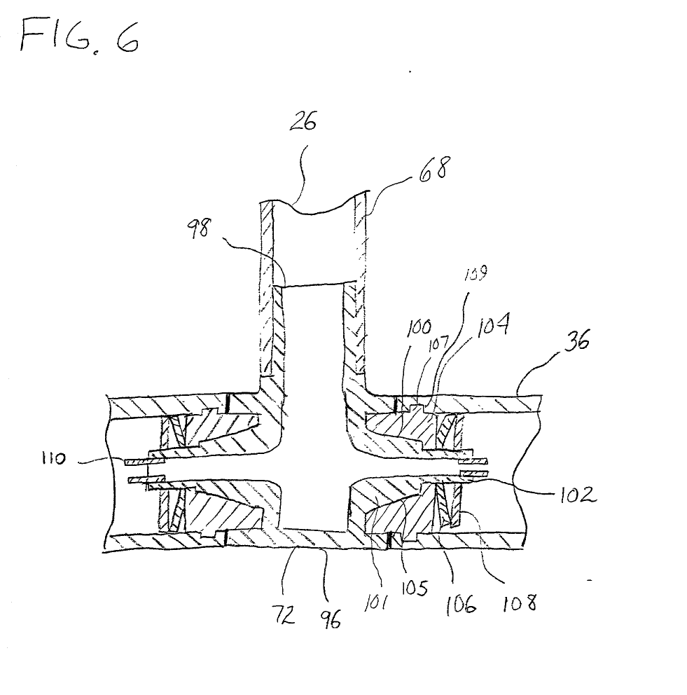

Referring additionally to FIG. 6, it will be seen that attachment of the antenna mast 26 to the outside coupler unit arms 36 is accomplished by means of a friction pivot 72 secured to the bottom of the radome 68. The friction pivot 72 includes a hub 96 having a sleeve 98, which is snuggly fitted within the bottom opening of the tubular radome 68, and two opposite integrally formed projections 100, which fit within the opposite arms 36 of the outside coupler unit 22. The projections 100 include an inner conical portion 101 and an outer cylindrical portion 102. Frictional pivoting of the antenna mast 26 with respect to the outside coupler unit 22 is accomplished by providing a bushing 104, a wave washer 106 and a retaining ring 108 around each of the projections 100 of the hub 96. Specifically, the bushings 104 include an internal conical surface 105 which mates with the conical portions 101 of the hub projections 100. The wave washers 106 are trapped between the bushings 104 and the retaining rings 102, which are secured to the cylindrical portions 102 of the projections, to provide a biasing force against the bushings. This biasing force maintains a frictional engagement between the internal conical surface 105 of the bushing 104 and the inner conical portion 101 of the projection 100. The bushings 104 further include keys 107 that are seated within recesses 109 formed in the outside coupler unit arms 36 to prevent rotational movement of the bushings. Thus, the antenna mast 26 with attached hub 96 pivots about the arms 36 of the outside coupler unit 22 against the biasing force of the friction applied by the bushings 104 to the conical portions 101 of the hub projections 100.

The hub 96 is preferably substantially hollow to allow passage of the antenna wires 80 and 88 through the sleeve 98 and out of the cylindrical projections 102 of the hub. Preferably, cable seals 110 are provided in the hub 96 to protect the antenna wires as they exit the projections 102 of the hub.

The antenna of the present invention can be installed on a variety of automotive vehicles. Typically the antenna is installed on a rear window of a sedan or the window of a rear hatchback door of a sport utility vehicle (SUV) or minivan. Alternatively, the antenna can be mounted on a rear side window of the vehicle.

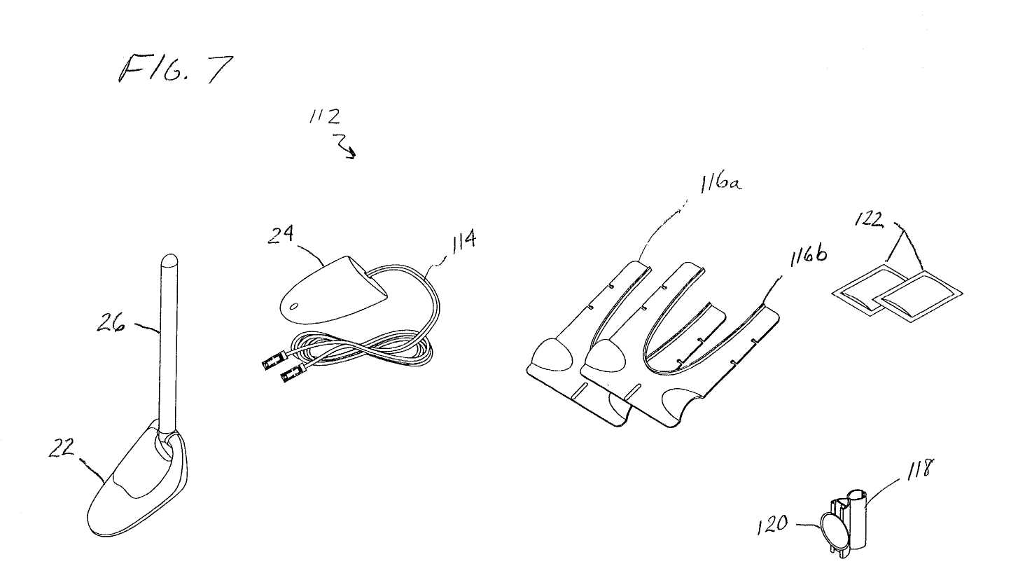

FIG. 7 illustrates the components that would be included in a kit 112 for installing the antenna of the present invention. The kit 112 includes the outside coupler unit 22 with the pivotally attached antenna mast 26, the inside coupler unit 24 with associated electrical wiring 114, two installation templates 116a and 116b, a protective mast holder 118 having a suction cup 120 and one or more cleaning towelettes 122.

Prior to installation of the antenna, a suitable site on the vehicle should be selected. A suitable site is one where the antenna would not block any part of the vehicle's brake lights or interfere with the driver's visibility during vehicle operation. Additionally, the core of the coupler units' electronics should not cross any antenna or defroster lines of a rear window. Ideally, the highest possible location on the vehicle's rear or side window that satisfies the conditions above without the interior coupler unit touching the vehicle's interior headliner should be chosen. Thus, it is desired to have the antenna mast rise above the roof line of the vehicle, as well as any other objects that are typically placed on the roof, to ensure a constant line of site to the satellites.

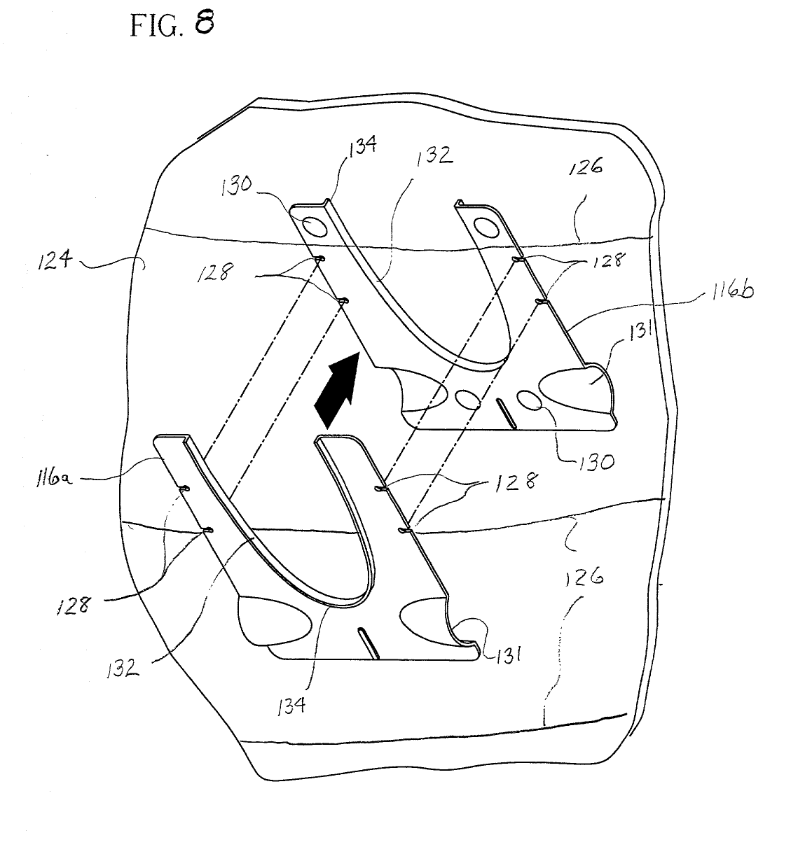

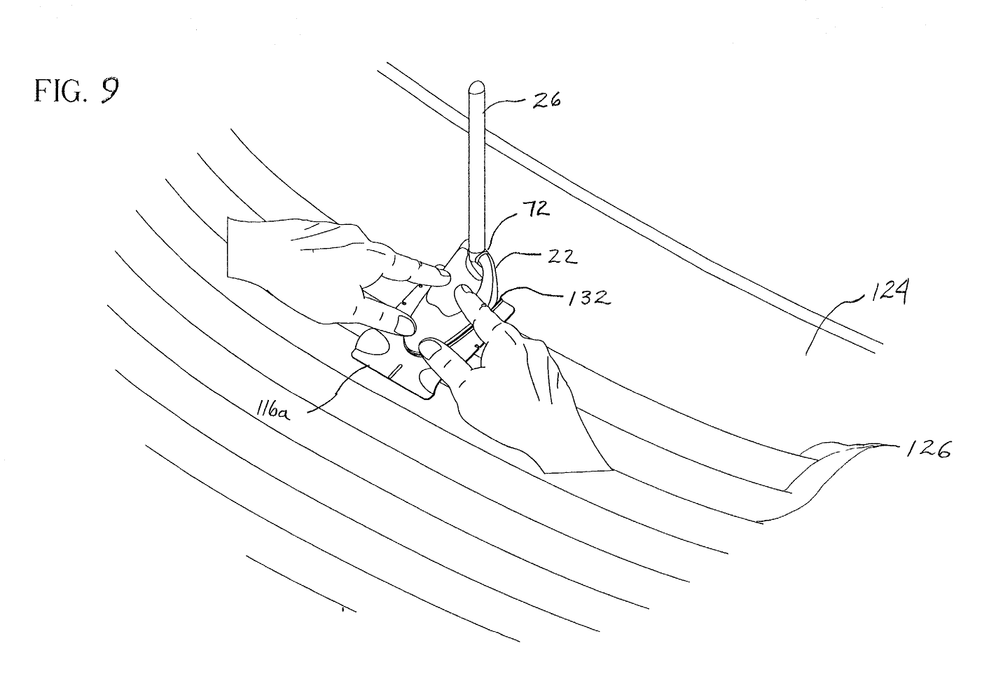

Referring to FIGS. 8 and 9, it is shown that, at the selected site, a cleaning towelette 122 of the kit 112 is used to clean the installation area on the vehicle's outside window 124. One of the installation templates 116a is then positioned on the vehicle's outside window 124 so that no defroster or antenna lines 126 are visible between registration notches or openings 128 provided on the template 116a. The templates 116a and 116b are also provided with at least one self-adhesive dot 130 that is exposed by peeling off a protective backing layer (not shown) from each of the dots. Once the template 116a is properly positioned, pressure is applied to the installation template to allow the adhesive dots 130 to secure the template to the window 124. Preferably, the self-adhesive dots 130 are made from a non-permanent adhesive to allow for easy repositioning and later removal of the installation templates 116a and 116b. The installation templates 116a and 116b also preferably include one or more recessed finger cavities 131 to facilitate grasping and positioning of the templates.

Each installation template 116a and 116b further includes a cut-out portion or opening 132 corresponding in size to the outside and inside coupler units 22 and 24, respectively. Extending around the perimeter of the opening 132 is a raised rib 134 to aid in positioning the outside and inside coupler units 22 and 24 within the opening of the installation templates 116a and 116b. Once the first installation template 116a has been properly positioned on the exterior surface of a window 124, the outside coupler unit 22, with pivotably attached antenna mast 26, can be placed within the opening 132 of the first installation template 116a, as shown in FIG. 9. At this point, it is important to check from the inside of the vehicle to verify that the electronic core of the outside coupler unit 22 does not cross any defroster or antenna lines 126 of the window 124.

If the template 116a is properly located, the protective backing layer 52 of the outside coupler unit 22 can be peeled away to expose the glass adhesive gasket 51 and the outside coupler unit can be pressed onto the exterior window surface 124 by applying steady hand pressure. Once the outside coupler unit 22 is secured in place, the antenna mast 26 can be adjusted by pivoting the mast about the friction pivot 72 so that antenna mast is substantially vertical (i.e., perpendicular) to the ground.

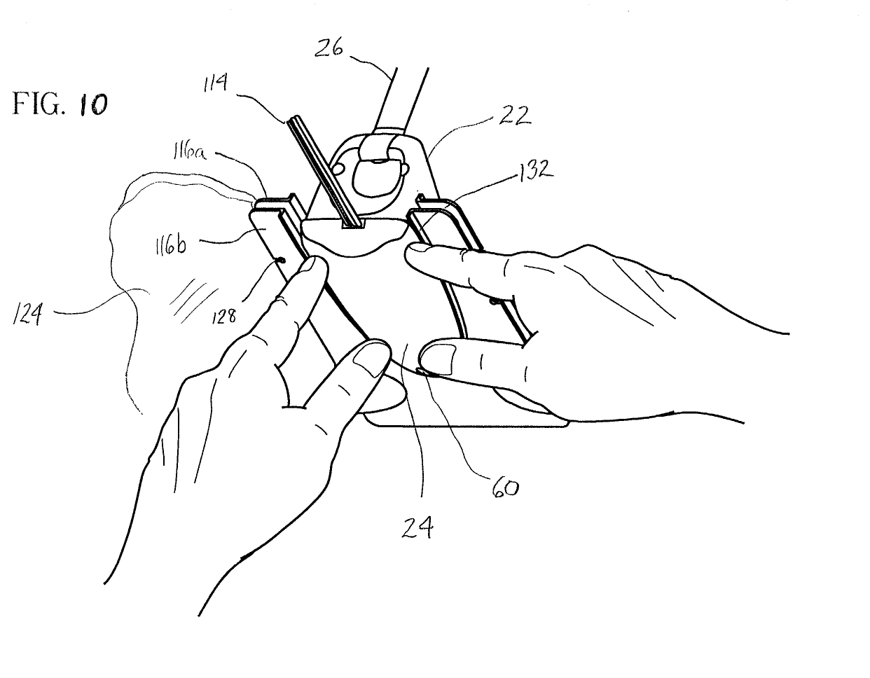

As shown in FIG. 10, the inside coupler unit 24 is positioned in a similar manner. At the corresponding interior site, a cleaning towelette 122 is used to clean the installation area on the vehicle's inside window 124. The second installation template 116b is then positioned on the inside window 124 so that its registration marks 128 align with those on the outside template 116a. The interior installation template 116b also includes self-adhesive dots 130 for helping secure the template to the interior of the window 124. The inside coupler unit 24 is then positioned within the opening 132 of the interior installation template 116b in a similar manner as that of the outside coupler 22. Once positioned, the protective backing layer 66 of the inside coupler 24 can be removed to expose the adhesive layer gasket 65 to allow adhesion of the inside coupler to the interior surface of the window 124.

As mentioned above, in a preferred embodiment of the present invention, the CCA board 48 of the outside coupler unit 22 includes one or more positioning LEDs 221 that are visible from the interior of the vehicle through the lightpipe 60 provided in the inside coupler unit 24 for ensuring proper alignment between the outside coupler and the inside coupler. The positioning LEDs 221, which will be discussed in further detail below, are designed to illuminate when the outside coupler unit 22 is properly receiving power or current for the electronics through the window from the inside coupler unit 24. In the preferred embodiment, the inside coupler unit 24 must be connected via the inside coupler's associated wiring 114 to the vehicle's audio system during installation of the inside and outside coupler units. If the positioning LED 221 is not illuminated, either the outside coupler 22 or the inside coupler 24 can be repositioned until the LED is illuminated. Once the inside coupler unit 24 is properly positioned, as indicated by the positioning LED 221, the protective backing label 66 from the inside coupler unit can be peeled away and the unit can be secured to the interior surface of the window 124 by means of the adhesive layer 64 on the inside coupler unit. Once both the inside and the outside coupler units 22 and 24 have been secured in place, the installation templates 116a and 116b may be removed from the vehicle window 124.

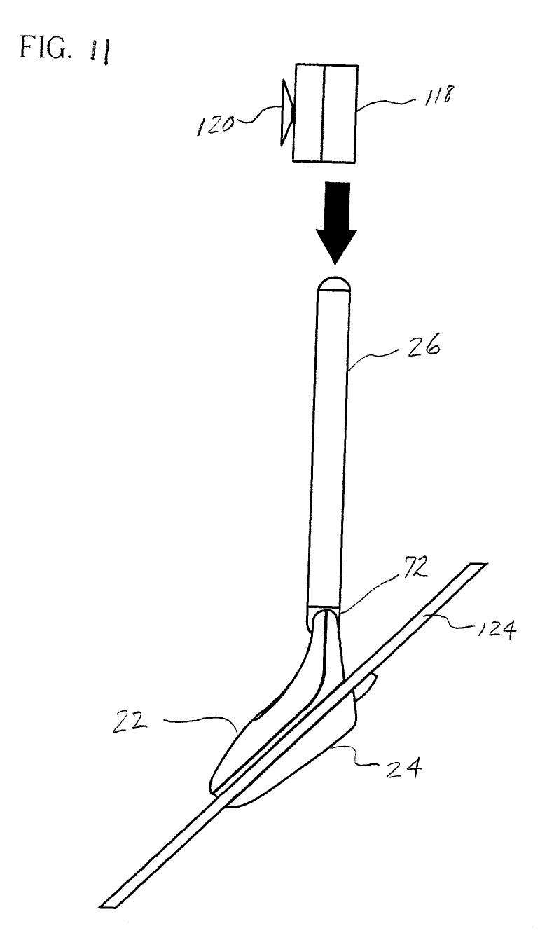

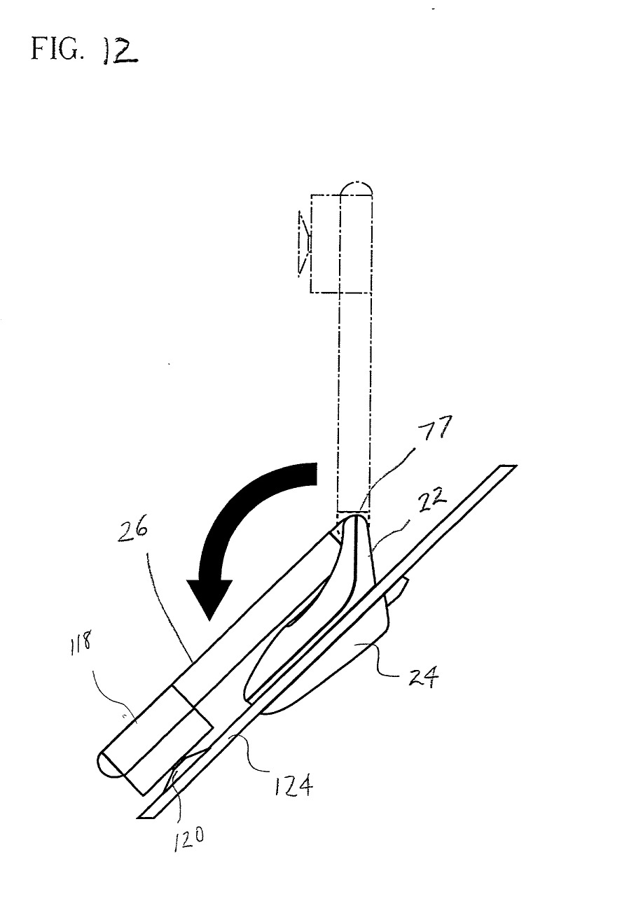

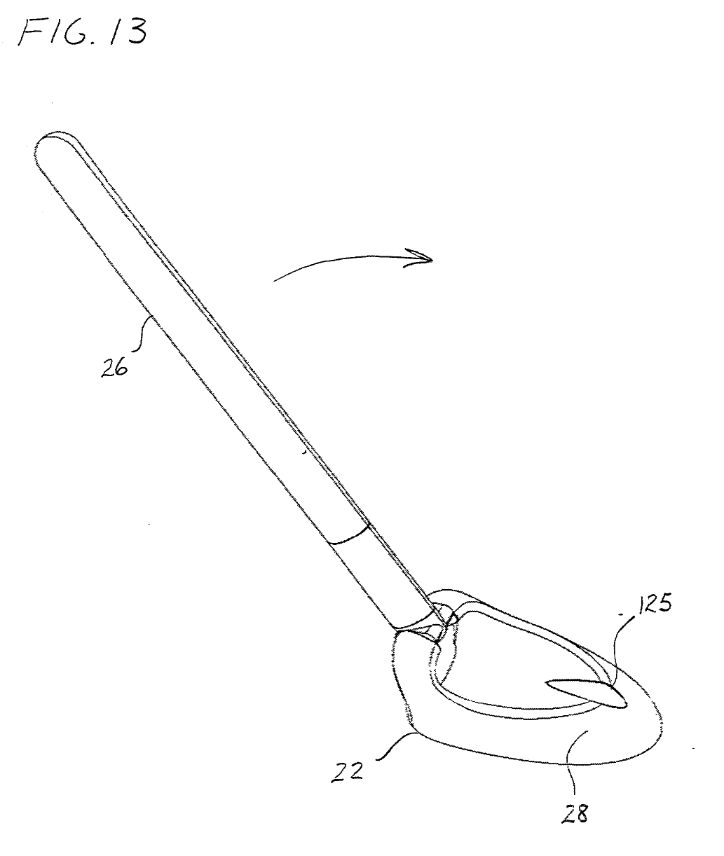

Referring to FIGS. 11 and 12, the antenna kit 112 further preferably includes a mast holder 118 having a suction cup 120. The mast holder 118 is essentially an extruded tube sized to be slipped over the antenna mast 26. Secured to the mast holder 118 is a suction cup 120 which is used to secure the antenna mast 26 to the surface of the window 124 in a folded down orientation to protect the antenna mast in damage prone situations, such as car washes and other low clearance situations. Alternatively, the suction cup 120 can be assembled directly to the antenna mast 26. In another alternative embodiment, as shown in FIG. 13, the outside coupler unit 22 may include a snap-in cavity 125 integrally formed on the upper surface of the top housing 28 for receiving and frictionally securing thereto the antenna mast 26 in a folded down orientation.

The antenna of the present invention operates using through-glass technology similar to that described in U.S. Pat. Nos. 5,612,652 and 5,929,718, which issued to Crosby, the disclosures of which are incorporated herein by reference. In particular, the inside coupler PCB assembly 58 includes circuitry that is electrically connected to the automobile's audio system receiver through a pair of coaxial cables 114. The antenna wires 80 and 88 from the satellite antenna 74 and the terrestrial antenna 76 are electrically connected to the outside coupler's CCA LNA board 44, which in turn is electrically connected to the outside coupler's CCA board 48. The outside coupler unit 22 provides RF signals from the satellite and terrestrial antennas 74 and 76 to the inside coupler unit 24 and the inside coupler unit provides power from the automobile's receiver to the outside coupler unit.

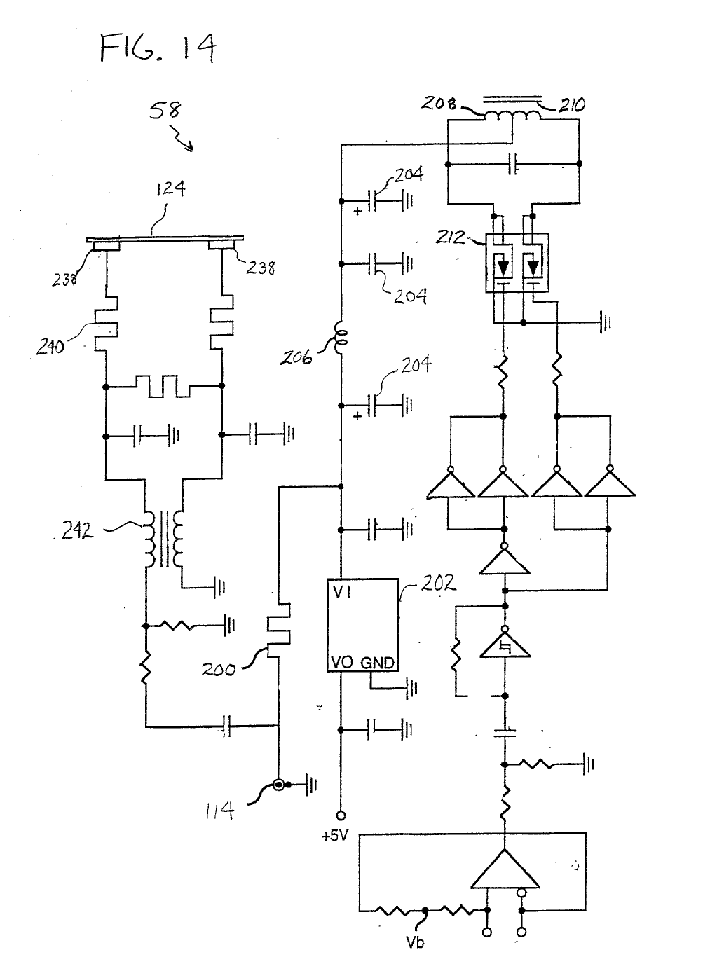

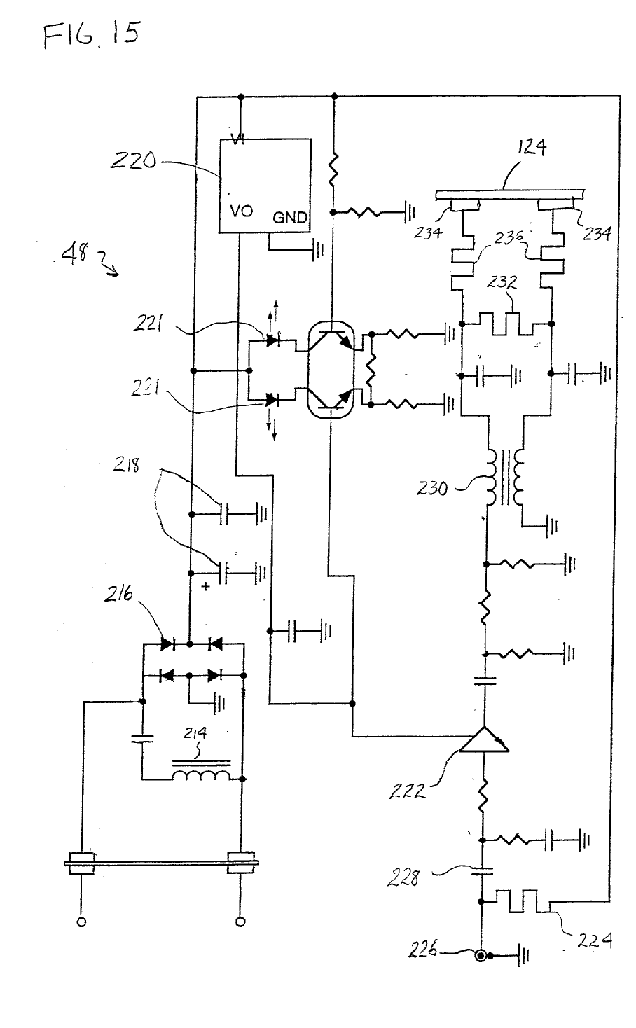

More specifically, as shown in the electrical schematics of FIGS. 14 and 15, the coaxial cables 114 provide DC electrical power from the automobile's receiver to the inside coupler PCB assembly 58. The electrical power flows from the coaxial cable 114 to an inductor 200 of the PCB assembly 58 for blocking RF signals from entering subsequent components of the power transmission circuitry. A voltage regulator 202 and a filter network including capacitors 204 and a wound inductor 206 are provided on the PCB assembly 58 to filter the direct current (DC) power. The filtered DC power is then conducted to a tapped inductor 208, which has a movable core 210. The tapped inductor 208 is positioned on the PCB assembly 58 to be adjacent the window glass when the inside coupler unit 24 is installed. The tapped inductor 208 is connected to a MOSFET 212 that converts the DC power input to the tapped inductor 208 into an alternating magnetic field, which is then used to transmit the power across the gap created by the thickness of the automobile window via magnetic induction.

Referring now to FIG. 15, it will be seen that the outside coupler unit CCA board 48 includes an inductor 214 positioned on the CCA board to be adjacent the window glass when the outside coupler unit 22 is installed. Thus, when the inside and outside coupler units 22 and 24 are properly aligned, the magnetic field produced by the inside coupler inductor 208 extends to the region occupied by the outside coupler inductor 214. The time-varying magnetic field produced by the inside coupler inductor 208 thus induces a current in the outside coupler inductor 214.

The outside coupler CCA board 48 further includes a diode network 216 (e.g., a full wave bridge rectifier circuit) and a pair of capacitors 218 for filtering the output voltage of the diode network. The DC power from the diode network 216 is delivered to a voltage regulator 220, which provides a regulated 5 volt DC output. Connected to the voltage regulator 220 are the one or more positioning LEDs 221, which will illuminate when the voltage regulator is providing a 5 volt DC output, which occurs when the outside and inside coupler units 22 and 24 are properly aligned with each other. The positioning LEDs 221 are situated on the outside coupler CCA board 48 to be adjacent the window glass 124 and opposite the lightpipe 60 of the inside coupler unit 24 when the outside coupler unit 22 is installed.

The output of the voltage regulator 220 also provides a bias voltage to a low noise amplifier 222, which is part of the RF signal transmission circuitry, and provides a voltage to an inductor 224. The inductor 224 is connected between the voltage regulator 220 and the input 226 of the antenna electronics to provide a conducting path for the DC power that is delivered to the antenna electronics located on the CCA LNA board 44 of the outside coupler unit 22.

The RF signals from the antenna electronics of the CCA LNA board 44 are provided at the input 226 of the CCA board 48 and are coupled into the interface circuit by a capacitor 228. The RF signals are conditioned and then enter a balun 230 that converts the unbalanced feed from the amplifier 222 into a balanced feed. The balanced output of the balun 230 is applied across an inductor 232 having its terminals connected to plates 234 through additional inductors 236. The plates 236 are positioned on the CCA board 48 to be adjacent the window glass 124 when the outside coupler unit 22 is installed.

Referring additionally back to FIG. 14, it will be seen that the plates 234 on the CCA board 48 of the outside coupler unit 22 are located opposite plates 238 provided on the inside coupler PCB assembly 58 when the inside and outside coupler units are properly installed. The opposing pairs of plates 234 and 238 form capacitors that couple the balanced RF signals through the window 124. RF signals from the outside coupler unit 22 enter the inside coupler unit 24 through the plates 238 and are provided to an inductor arrangement 240 and balun 242 similar to those described with respect to the outside coupler CCA board 48. Unbalanced signals output from the balun 242 are then provided to the inside coupler unit's electrical wiring 114, which in turn are sent to the automobile's audio receiver. The electronic circuits shown in FIGS. 14 and 15 are described in greater detail in the aforementioned Crosby patents.

Thus, as a result of the present invention, an aerodynamically designed antenna that offers all of the benefits of satellite radio, in addition to terrestrial radio reception, is provided. The antenna complements the appearance of any vehicle and uses a through-glass technology to eliminate drilling during installation. The antenna mast is fully adjustable allowing it to be set at any angle for optimum reception on any surface. Additionally, the mast can be completely folded down to avoid damage at car washes and in other low-clearance situations. A kit is also provided which includes all of the necessary mounting hardware to enable easy installation on most vehicles.

Although illustrative embodiments of the present invention have been described herein with reference to the accompanying drawings, it is to be understood that the invention is not limited to those precise embodiments and that various other changes may be effected herein by one skilled in the art without departing from the scope or the spirit of the invention.

What is claimed is:

1. An automobile radio antenna comprising:
an outside coupler unit adapted to be mounted to an exterior surface of an automobile window;
an inside coupler unit adapted to be mounted to an interior surface of an automobile window and aligned with the outside coupler unit; and
an antenna mast pivotably attached to the outside coupler unit, the antenna mast being angularly adjustable with respect to the outside coupler unit.

2. An automobile radio antenna as defined in claim 1, wherein the outside coupler unit comprises a housing having a main body and two upwardly extending arms, the antenna mast being pivotably attached to the upwardly extending arms.

3. An automobile radio antenna as defined in claim 2, wherein the upwardly extending arms define an opening in the outside coupler unit to allow the passage of wind through the outside coupler unit.

4. An automobile radio antenna as defined in claim 2, wherein the upwardly extending arms are adapted to project the antenna mast above an automobile roof line to ensure a proper line of sight for the antenna mast to a satellite.

5. An automobile radio antenna as defined in claim 1, wherein the outside coupler unit is adapted to receive radio signals from the antenna mast and electrical power from the inside coupler unit and is adapted to send the radio signals from the antenna mast to the inside coupler unit, and wherein the inside coupler unit is adapted to receive the radio signals from the outside coupler unit and is adapted to send electrical power to the outside coupler unit.

6. An automobile radio antenna as defined in claim 1, wherein the outside and inside coupler units each include an adhesive gasket for adhesively mounting the outside and inside coupler units to the automobile window.

7. An automobile radio antenna as defined in claim 1, wherein the outside coupler unit includes a positioning LED, the positioning LED illuminating when the outside and inside coupler units are properly aligned.

8. An automobile radio antenna as defined in claim 1, wherein the antenna mast includes a satellite antenna assembly for receiving satellite radio signals, a terrestrial antenna assembly for receiving terrestrial radio signals and a radome for containing the satellite antenna assembly and the terrestrial antenna assembly therein.

9. An automobile radio antenna as defined in claim 8, wherein the satellite antenna assembly and the terrestrial antenna assembly are linearly aligned within the radome of the antenna mast.

10. An automobile radio antenna as defined in claim 1, wherein the antenna mast includes a friction pivot assembly, the friction pivot assembly being pivotably attached to the outside coupler unit for providing a biasing frictional force against angular adjustment of the antenna mast.

11. An automobile radio antenna as defined in claim 10, wherein the friction pivot comprises:
a cylindrical hub having an axial projection; and
a bushing fitted on the hub projection for rotational frictional engagement therewith.

12. An automobile radio antenna as defined in claim 11, wherein the friction pivot further comprises:
a wave washer fitted on the hub projection for providing a biasing force against the bushing to maintain frictional engagement between the bushing and the hub projection.

13. An automobile radio antenna as defined in claim 1, wherein the antenna mast includes a suction cup for securing the antenna mast to the automobile window in a folded down orientation.

14. An automobile radio antenna as defined in claim 1, wherein the outside coupler unit includes a snap-in cavity integrally formed on an upper surface thereof for receiving and securing thereto the antenna mast in a folded down orientation.

15. A kit for installing an automobile radio antenna on a window of an automobile comprising:
an outside coupler unit adapted to be mounted to an exterior surface of an automobile window and having an antenna mast connected thereto;
an inside coupler unit adapted to be mounted to an interior surface of an automobile window and aligned with the outside coupler unit;
an outside coupler unit template having a cut-out portion for positioning the outside coupler unit on the exterior surface of the automobile window; and
an inside coupler unit template having a cut-out portion for positioning the in side coupler on the interior surface of the automobile window.

16. The kit as defined in claim 15, further comprising:
a protective mast holder including a tubular sleeve adapted to be fitted on the antenna mast and a suction cup for securing the antenna mast to the automobile window in a folded down orientation.

17. The kit as defined in claim 15, wherein the outside and inside coupler unit templates include registration notches for positioning and aligning the templates on the automobile window.

18. The kit as defined in claim 15, wherein the outside and inside coupler unit templates each include at least one self-adhesive portion for temporarily securing the template to the automobile window.

19. A method for installing an automobile radio antenna on an automobile window comprising the steps of:
positioning an outside coupler unit template having a cut-out portion on an exterior surface of the automobile window;
aligning an inside coupler unit template having a cut-out portion with the outside coupler unit template on an interior surface of the automobile window;
mounting an outside coupler unit having an antenna mast assembly to an exterior surface of the automobile window by positioning the outside coupler unit within the cut-out portion of the outside coupler unit template;
mounting an inside coupler unit for electrically communicating with the outside coupler unit to an interior surface of the automobile window by positioning the inside coupler unit within the cut-out portion of the inside coupler unit template; and
removing the outside and inside coupler unit templates from the automobile window once the outside and inside coupler units have been mounted to the window.

20. The method as defined in claim 19, further comprising the steps of:
electrically connecting the inside coupler unit to the automobile's receiver; and
illuminating a positioning LED provided on one of the outside and inside coupler units when the outside and inside coupler units are properly aligned.

21. The method as defined in claim 19, wherein the steps of positioning and aligning the outside and inside coupler unit templates include the step of positioning registration notches formed on the templates clear of any defroster or antenna lines on the automobile window.

22. The method as defined in claim 19, further comprising the step of angularly adjusting the antenna mast assembly with respect to the outside coupler unit once the outside coupler unit is mounted to the automobile window.
